(19) United States
(12) Patent Application Publication
(10) Pub. No.: US 2026/0189888 A1
(43) Pub. Date: Jul. 2, 2026

(54) METHOD FOR TRANSMITTING/RECEIVING SIGNALS AND DEVICE FOR SAME IN WIRELESS COMMUNICATION SYSTEM

(71) Applicant: LG ELECTRONICS INC., Seoul (KR)

(72) Inventors: Minsung KWAK, Seoul (KR); Hanbyul SEO, Seoul (KR); Jaihyun BYUN, Seoul (KR)

(21) Appl. No.: 19/131,170

(22) PCT Filed: Jan. 9, 2024
(86) PCT No.: PCT/KR2024/000372

§ 371 Date: May 19, 2025

(30) Foreign Application Priority Data
Jan. 9, 2023 (KR) 10-2023-0002923

(51) Int. Cl. H04W 4/44; H04W 4/38

(52) U.S. Cl. CPC H04W 4/44; H04W 4/38

(57) ABSTRACT

A method for a first device to transmit signals in an intelligent transport system (ITS) according to various embodiments comprises the steps of: acquiring first sensor data via a first sensor; receiving, from a second device, second sensor data detected via a second sensor different from the first sensor; and transmitting a vehicle-to-everything (V2X) message including object detection information on the basis of the first sensor data, wherein the first device may determine the object detection information included in the V2X message on the basis of whether the first sensor data conflicts with the second sensor data.

### TECHNICAL FIELD

The present disclosure relates to signal transmission and reception in a wireless communication system, and more particularly, to a method of transmitting or receiving signals related to an intelligent transport system (ITS) and device therefor.

### BACKGROUND

Wireless communication systems have been widely deployed to provide various types of communication services such as voice or data. In general, a wireless communication system is a multiple access system that supports communication of multiple users by sharing available system resources (a bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multi carrier frequency division multiple access (MC-FDMA) system.

A sidelink (SL) refers to a communication method in which a direct link is established between user equipment (UE), and voice or data is directly exchanged between UEs without going through a base station (BS). SL is being considered as one way to solve the burden of the base station due to the rapidly increasing data traffic.

V2X (vehicle-to-everything) refers to a communication technology that exchanges information with other vehicles, pedestrians, and infrastructure-built objects through wired/wireless communication. V2X may be divided into four types: vehicle-to-vehicle (V2V), vehicle-to-infrastructure (V2I), vehicle-to-network (V2N), and vehicle-to-pedestrian (V2P). V2X communication may be provided through a PC5 interface and/or a Uu interface.

As more and more communication devices require larger communication capacities in transmitting and receiving signals, there is a need for mobile broadband communication improved from the legacy radio access technology. Accordingly, communication systems considering services/UEs sensitive to reliability and latency are under discussion. A next-generation radio access technology in consideration of enhanced mobile broadband communication, massive Machine Type Communication (MTC), and Ultra-Reliable and Low Latency Communication (URLLC) may be referred to as new radio access technology (RAT) or new radio (NR). Even in NR, vehicle-to-everything (V2X) communication may be supported.

FIG. 1 is a diagram comparing RAT-based V2X communication before NR with NR-based V2X communication.

Regarding V2X communication, in RAT prior to NR, a scheme for providing a safety service based on V2X messages such as a basic safety message (BSM), a cooperative awareness message (CAM), and a decentralized environmental notification message (DENM) was mainly discussed. The V2X message may include location information, dynamic information, and attribute information. For example, the UE may transmit a periodic message type CAM and/or an event triggered message type DENM to another UE.

For example, the CAM may include dynamic state information about a vehicle such as direction and speed, vehicle static data such as dimensions, and basic vehicle information such as external lighting conditions and route details. For example, a UE may broadcast the CAM, and the CAM latency may be less than 100 ms. For example, when an unexpected situation such as a breakdown of the vehicle or an accident occurs, the UE may generate a DENM and transmit the same to another UE. For example, all vehicles within the transmission coverage of the UE may receive the CAM and/or DENM. In this case, the DENM may have a higher priority than the CAM.

Regarding V2X communication, various V2X scenarios have been subsequently introduced in NR. For example, the various V2X scenarios may include vehicle platooning, advanced driving, extended sensors, and remote driving.

For example, based on vehicle platooning, vehicles may dynamically form a group and move together. For example, to perform platoon operations based on vehicle platooning, vehicles belonging to the group may receive periodic data from a leading vehicle. For example, the vehicles belonging to the group may reduce or increase the distance between the vehicles based on the periodic data.

For example, based on advanced driving, a vehicle may be semi-automated or fully automated. For example, each vehicle may adjust trajectories or maneuvers based on data acquired from local sensors of nearby vehicles and/or nearby logical entities. Also, for example, each vehicle may share driving intention with nearby vehicles.

For example, on the basis of extended sensors, raw data or processed data acquired through local sensors, or live video data may be exchanged between a vehicle, a logical entity, UEs of pedestrians and/or a V2X application server. Thus, for example, the vehicle may recognize an environment that is improved over an environment that may be detected using its own sensor.

For example, for a person who cannot drive or a remote vehicle located in a dangerous environment, a remote driver or V2X application may operate or control the remote vehicle based on remote driving. For example, when a route is predictable as in the case of public transportation, cloud computing-based driving may be used to operate or control the remote vehicle. For example, access to a cloud-based back-end service platform may be considered for remote driving.

A method to specify service requirements for various V2X scenarios such as vehicle platooning, advanced driving, extended sensors, and remote driving is being discussed in the NR-based V2X communication field.

### DISCLOSURE

### Technical Problem

The present disclosure aims to provide a method and device for more accurately and efficiently transmitting and receiving vehicle-to-everything (V2X) messages in an intelligent transport system (ITS).

It will be appreciated by persons skilled in the art that the objects that could be achieved with the various embodiments of the present disclosure are not limited to what has been particularly described hereinabove and the above and other objects that the various embodiments of the present disclosure could achieve will be more clearly understood from the following detailed description.

### Technical Solution

According to an aspect, a method for transmitting a signal in an intelligent transportation system (ITS) by a first device may include acquiring first sensor data through a first sensor, receiving second sensor data detected through a second sensor different from the first sensor from a second device, and transmitting a vehicle-to-everything (V2X) message including object detection information based on the first sensor data. The first device may determine the object detection information included in the V2X message, based on whether the first sensor data conflicts with the second sensor data.

According to another aspect, a computer-readable recording medium having recorded thereon a program for performing the above method may be provided.

According to another aspect, a first device for transmitting a signal in an ITS may include a first sensor, a transceiver, and a processor controlling the first sensor and the transceiver. The processor may acquire first sensor data through the first sensor, receive second sensor data detected through a second sensor different from the first sensor from a second device, and transmit a V2X message including object detection information based on the first sensor data. The processor may determine the object detection information included in the V2X message, based on whether the first sensor data conflicts with the second sensor data.

Based on that the first sensor data conflicts with the second sensor data, the object detection information may include information about high-definition (HD) data of the first sensor data, which is not processed by the first device. The information about the HD data may include address information for accessing the HD data. The information about the HD data may include at least one of valid time information, video type information, maximum resolution information, or maximum frame number information, about the HD data.

Based on that the first sensor data does not conflict with the second sensor data, the first device may configure the object detection information by processing the first sensor data.

The V2X message may include information about a type of the second device providing the second sensor data. The type of the second device may relate to whether the second device is a road side unit (RSU) or a central-intelligent transportation system (C-ITS) server.

Based on that a confidence level for an object detected through the first sensor is less than a threshold, the object detection information may include information about HD data of the first sensor data, which is not processed by the first device.

Based on that an object that cannot be identified by the first device is detected through the first sensor, the object detection information may include information about HD data of the first sensor data, which is not processed by the first device.

Based on that a predefined emergency situation occurs, the object detection information may include information about HD data of the first sensor data, which is not processed by the first device.

### Advantageous Effects

According to an embodiment of the disclosure, V2X messages may be transmitted and received more accurately and more efficiently in an ITS.

Effects to be achieved by embodiment(s) are not limited to what has been particularly described hereinabove and other effects not mentioned herein will be more clearly understood by persons skilled in the art to which embodiment(s) pertain from the following detailed description.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure.

FIG. 1 is a diagram for explaining the comparison between vehicle-to-everything (V2X) communication based on radio access technology (RAT) before New Radio (NR) and V2X communication based on NR.

FIG. 2 illustrates the structure of a Long-Term Evolution (LTE) system to which embodiment(s) are applicable.

FIG. 3 illustrates the structure of an NR system to which embodiment(s) are applicable.

FIG. 4 illustrates the structure of an NR radio frame to which embodiment(s) are applicable.

FIG. 5 illustrates the slot structure of an NR frame to which embodiment(s) are applicable.

FIG. 6 illustrates a radio protocol architecture for SL communication.

FIG. 7 illustrates UEs performing V2X or SL communication.

FIG. 8 illustrates resource units for V2X or SL communication.

FIG. 9 is a diagram illustrating transmission of sensor-recognized detection information from a conventional ITS station.

FIG. 10 illustrates an example in which an ITS station equipped with a sensor provides information to a neighboring ITS station.

FIGS. 11 and 12 illustrate examples of various environments in which unprocessed HD data is transmitted.

FIG. 13 is a diagram illustrating service set-up of receiving ITS stations.

FIG. 14 illustrates an exemplary SDSM.

FIG. 15 illustrates an exemplary RSM.

FIG. 16 illustrates an exemplary HD Data Request Message.

FIG. 17 illustrates an operation of a transmitting ITS station according to an embodiment.

FIG. 18 illustrates an operation of a receiving ITS station according to an embodiment.

FIG. 19 illustrates a signal transmission and reception operation of an ITS station according to an embodiment.

FIG. 20 is a flowchart illustrating a signal transmission method according to an embodiment.

FIG. 21 illustrates a communication system applied to the present disclosure.

FIG. 22 illustrates wireless devices applicable to the present disclosure.

FIG. 23 illustrates another example of a wireless device to which the present disclosure is applied.

FIG. 24 illustrates a vehicle or an autonomous driving vehicle applied to the present disclosure.

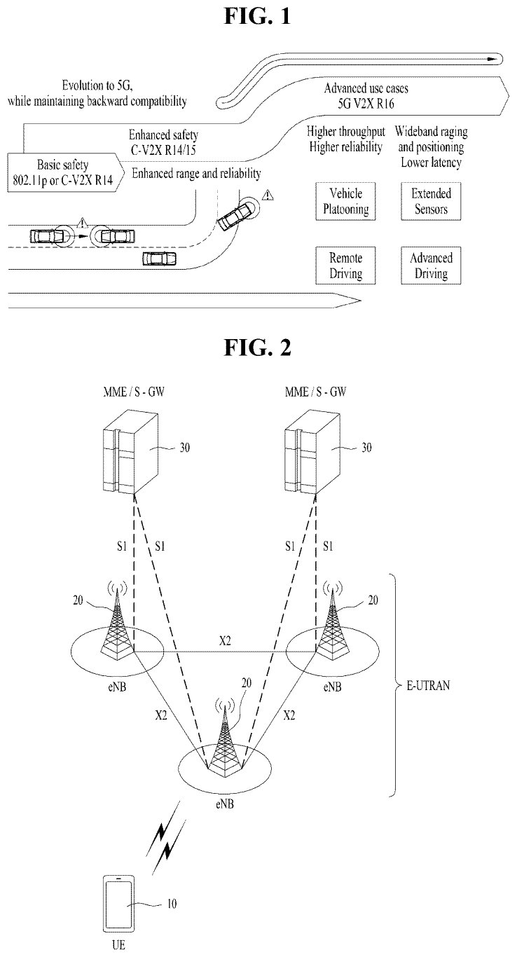

### DETAILED DESCRIPTION

The wireless communication system is a multiple access system that supports communication with multiple users by sharing available system resources (e.g., bandwidth, transmission power, etc.). Examples of the multiple access system include a code division multiple access (CDMA) system, a frequency division multiple access (FDMA) system, a time division multiple access (TDMA) system, an orthogonal frequency division multiple access (OFDMA) system, a single carrier frequency (SC-FDMA) system, a multi carrier frequency division multiple access (MC-FDMA) system, and the like.

A sidelink refers to a communication scheme in which a direct link is established between user equipments (UEs) to directly exchange voice or data between UEs without assistance from a base station (BS). The sidelink is being considered as one way to address the burden on the BS caused by rapidly increasing data traffic.

Vehicle-to-everything (V2X) refers to a communication technology for exchanging information with other vehicles, pedestrians, and infrastructure-built objects through wired/wireless communication. V2X may be divided into four types: vehicle-to-vehicle (V2V), vehicle-to-infrastructure (V2I), vehicle-to-network (V2N), and vehicle-to-pedestrian (V2P). V2X communication may be provided through a PC5 interface and/or a Uu interface.

As more and more communication devices require larger communication capacities in transmitting and receiving signals, there is a need for mobile broadband communication improved from the legacy radio access technology. Accordingly, communication systems considering services/UEs sensitive to reliability and latency are under discussion. A next-generation radio access technology in consideration of enhanced mobile broadband communication, massive MTC, and Ultra-Reliable and Low Latency Communication (URLLC) may be referred to as new radio access technology (RAT) or new radio (NR). Even in NR, V2X communication may be supported.

Techniques described herein may be used in various wireless access systems such as code division multiple access (CDMA), frequency division multiple access (FDMA), time division multiple access (TDMA), orthogonal frequency division multiple access (OFDMA), single carrier-frequency division multiple access (SC-FDMA), etc. CDMA may be implemented as a radio technology such as universal terrestrial radio access (UTRA) or CDMA2000. TDMA may be implemented as a radio technology such as global system for mobile communications (GSM)/general packet radio service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, evolved-UTRA (E-UTRA) etc. UTRA is a part of universal mobile telecommunications system (UMTS). 3GPP LTE is a part of Evolved UMTS (E-UMTS) using E-UTRA. 3GPP LTE employs OFDMA for downlink and SC-FDMA for uplink. LTE-A is an evolution of 3GPP LTE. 3GPP NR (New Radio or New Radio Access Technology) is an evolved version of 3GPP LTE/LTE-A/LTE-A pro.

5G NR is a successor technology of LTE-A, and is a new clean-slate mobile communication system with characteristics such as high performance, low latency, and high availability. 5G NR may utilize all available spectrum resources, from low frequency bands below 1 GHz to intermediate frequency bands from 1 GHz to 10 GHz and high frequency (millimeter wave) bands above 24 GHz.

For clarity of explanation, LTE-A or 5G NR is mainly described, but the technical spirit of the embodiment(s) is not limited thereto

FIG. 2 illustrates the structure of an LTE system to which the present disclosure is applicable. This may also be called an evolved UMTS terrestrial radio access network (E-UTRAN) or LTE/LTE-A system.

Referring to FIG. 2, the E-UTRAN includes evolved Node Bs (eNBs) 20 which provide a control plane and a user plane to UEs 10. A UE 10 may be fixed or mobile, and may also be referred to as a mobile station (MS), user UE (UT), subscriber station (SS), mobile UE (MT), or wireless device. An eNB 20 is a fixed station communication with the UE 10 and may also be referred to as a base station (BS), a base transceiver system (BTS), or an access point.

eNBs 20 may be connected to each other via an X2 interface. An eNB 20 is connected to an evolved packet core (EPC) 39 via an S1 interface. More specifically, the eNB 20 is connected to a mobility management entity (MME) via an S1-MME interface and to a serving gateway (S-GW) via an S1-U interface.

The EPC 30 includes an MME, an S-GW, and a packet data network-gateway (P-GW). The MME has access information or capability information about UEs, which are mainly used for mobility management of the UEs. The S-GW is a gateway having the E-UTRAN as an end point, and the P-GW is a gateway having a packet data network (PDN) as an end point.

Based on the lowest three layers of the open system interconnection (OSI) reference model known in communication systems, the radio protocol stack between a UE and a network may be divided into Layer 1 (L1), Layer 2 (L2) and Layer 3 (L3). These layers are defined in pairs between a UE and an Evolved UTRAN (E-UTRAN), for data transmission via the Uu interface. The physical (PHY) layer at L1 provides an information transfer service on physical channels. The radio resource control (RRC) layer at L3 functions to control radio resources between the UE and the network. For this purpose, the RRC layer exchanges RRC messages between the UE and an eNB.

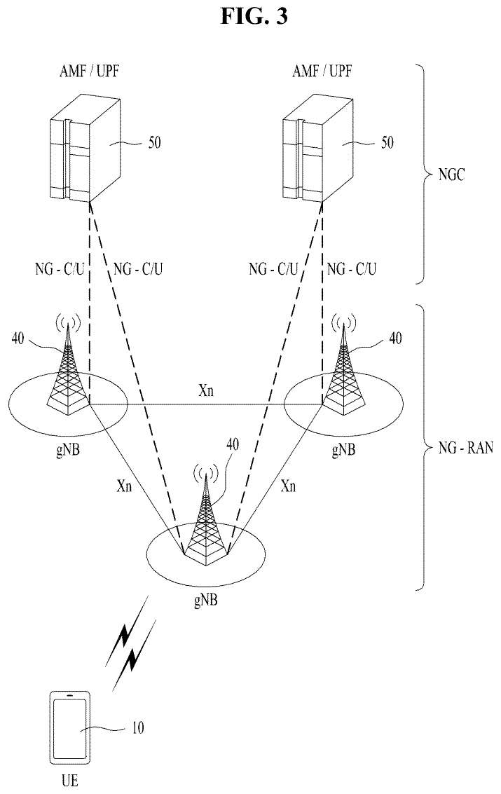

FIG. 3 illustrates the structure of a NR system to which the present disclosure is applicable.

Referring to FIG. 3, a next generation radio access network (NG-RAN) may include a next generation Node B (gNB) and/or an eNB, which provides user-plane and control-plane protocol termination to a UE. In FIG. 3, the NG-RAN is shown as including only gNBs, by way of example. A gNB and an eNB are connected to each other via an Xn interface. The gNB and the eNB are connected to a 5G core network (5GC) via an NG interface. More specifically, the gNB and the eNB are connected to an access and mobility management function (AMF) via an NG-C interface and to a user plane function (UPF) via an NG-U interface.

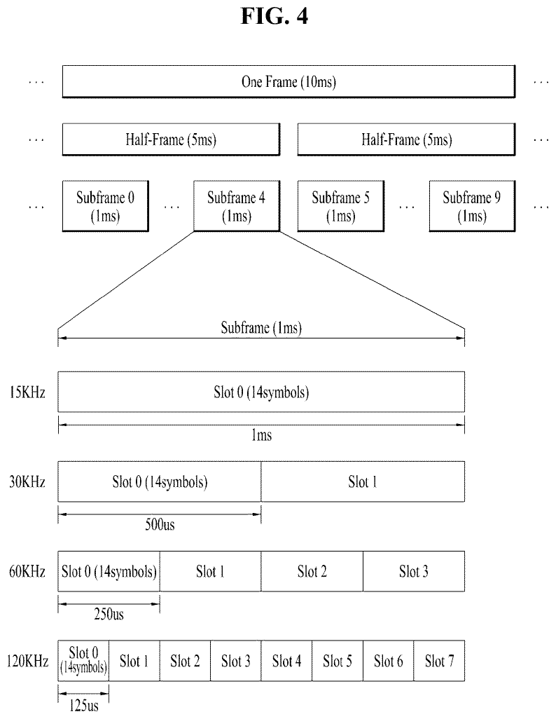

FIG. 4 illustrates the structure of a NR radio frame to which the present disclosure is applicable.

Referring to FIG. 4, a radio frame may be used for UL transmission and DL transmission in NR. A radio frame is 10 ms in length, and may be defined by two 5-ms half-frames. An HF may include five 1-ms subframes. A subframe may be divided into one or more slots, and the number of slots in an SF may be determined according to a subcarrier spacing (SCS). Each slot may include 12 or 14 OFDM (A) symbols according to a cyclic prefix (CP).

In a normal CP (NCP) case, each slot may include 14 symbols, whereas in an extended CP (ECP) case, each slot may include 12 symbols. Herein, a symbol may be an OFDM symbol (or CP-OFDM symbol) or an SC-FDMA symbol (or DFT-s-OFDM symbol).

Table 1 below lists the number of symbols per slot Nslotsymb, the number of slots per frame Nframe,uslot, and the number of slots per subframe Nsubframe,uslot according to an SCS configuration μ in the NCP case.

TABLE 1

| SCS (15*2u) | N^{slot}_{symb} | N^{frame, u}ₛₗₒₜ | N^{subframe, u}ₛₗₒₜ |
|---|---|---|---|
| 15 kHz (u = 0) | 14 | 10 | 1 |
| 30 kHz (u = 1) | 14 | 20 | 2 |
| 60 kHz (u = 2) | 14 | 40 | 4 |
| 120 kHz (u = 3) | 14 | 80 | 8 |
| 240 kHz (u = 4) | 14 | 160 | 16 |

Table 2 below lists the number of symbols per slot, the number of slots per frame, and the number of slots per subframe according to an SCS in the ECP case.

TABLE 2

| SCS (15*2\hat{ }u) | N^{slot}_{symb} | N^{frame, u}ₛₗₒₜ | N^{subframe, u}ₛₗₒₜ |
|---|---|---|---|
| 60 kHz (u = 2) | 12 | 40 | 4 |

In the NR system, different OFDM (A) numerologies (e.g., SCSs, CP lengths, etc.) may be configured for a plurality of cells aggregated for one UE. Thus, the (absolute) duration of a time resource (e.g., SF, slot, or TTI) including the same number of symbols may differ between the aggregated cells (such a time resource is commonly referred to as a time unit (TU) for convenience of description).

In NR, multiple numerologies or SCSs to support various 5G services may be supported. For example, a wide area in conventional cellular bands may be supported when the SCS is 15 kHz, and a dense urban environment, lower latency, and a wider carrier bandwidth may be supported when the SCS is 30 kHz/60 kHz. When the SCS is 60 kHz or higher, a bandwidth wider than 24.25 GHz may be supported to overcome phase noise.

The NR frequency band may be defined as two types of frequency ranges. The two types of frequency ranges may be FR1 and FR2. The numerical values of the frequency ranges may be changed. For example, the two types of frequency ranges may be configured as shown in Table 3 below. Among the frequency ranges used in the NR system, FR1 may represent “sub 6 GHz range” and FR2 may represent “above 6 GHz range” and may be called millimeter wave (mmW).

TABLE 3

| Frequency Range | Corresponding frequency | Subcarrier Spacing | |
|---|---|---|---|
| designation | range | (SCS) | |
| FR1 | 450 MHz-6000 MHz | 15, 30, 60 | kHz |
| FR2 | 24250 MHz-52600 MHz | 60, 120, 240 | kHz |

As mentioned above, the numerical values of the frequency ranges of the NR system may be changed. For example, FR1 may include a band of 410 MHz to 7125 MHz as shown in Table 4 below. That is, FR1 may include a frequency band of 6 GHZ (or 5850 MHz, 5900 MHz, 5925 MHz, etc.) or higher. For example, the frequency band of 6 GHz (or 5850 MHz, 5900 MHz, 5925 MHz, etc.) or higher included in FR1 may include an unlicensed band. The unlicensed band may be used for various purposes, for example, for communication for vehicles (e.g., autonomous driving).

TABLE 4

| Frequency Range | Corresponding frequency | Subcarrier Spacing | |
|---|---|---|---|
| designation | range | (SCS) | |
| FR1 | 410 MHz-7125 MHz | 15, 30, 60 | kHz |
| FR2 | 24250 MHz-52600 MHz | 60, 120, 240 | kHz |

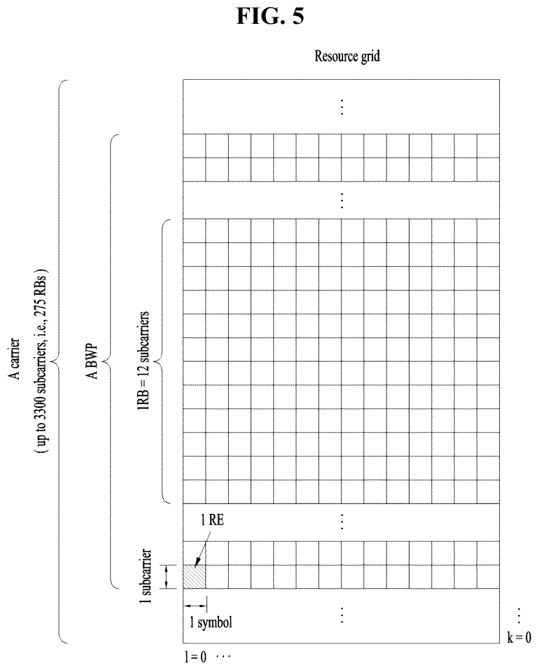

FIG. 5 illustrates the slot structure of a NR frame to which the present disclosure is applicable.

Referring to FIG. 5, one slot includes a plurality of symbols in the time domain. For example, one slot may include 14 symbols in a normal CP and 12 symbols in an extended CP. Alternatively, one slot may include 7 symbols in the normal CP and 6 symbols in the extended CP.

A carrier may include a plurality of subcarriers in the frequency domain. A resource block (RB) is defined as a plurality of consecutive subcarriers (e.g., 12 subcarriers) in the frequency domain. A bandwidth part (BWP) may be defined as a plurality of consecutive (P) RBs in the frequency domain, and the BWP may correspond to one numerology (e.g., SCS, CP length, etc.). The carrier may include up to N (e.g., 5) BWPs. Data communication may be conducted in an activated BWP. In a resource grid, each element may be referred to as a resource element (RE) and may be mapped to one complex symbol.

The wireless interface between UEs or the wireless interface between a UE and a network may be composed of an L1 layer, an L2 layer, and an L3 layer. In various embodiments of the present disclosure, the L1 layer may represent a physical layer. The L2 layer may represent, for example, at least one of a MAC layer, an RLC layer, a PDCP layer, and an SDAP layer. The L3 layer may represent, for example, an RRC layer.

Hereinafter, V2X or sidelink (SL) communication will be described.

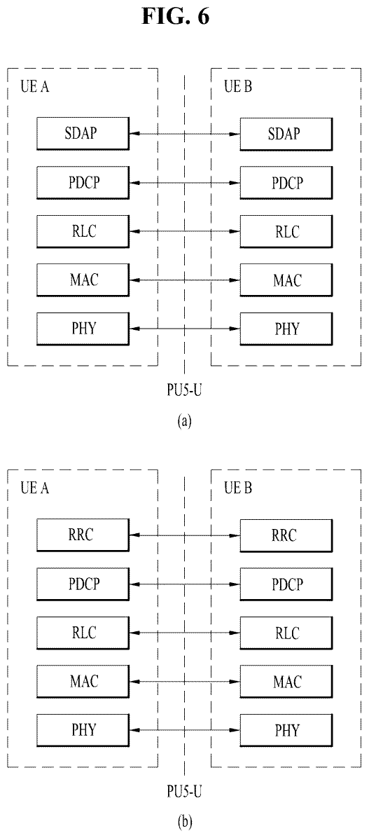

FIG. 6 illustrates a radio protocol architecture for SL communication. Specifically, FIG. 6-(a) shows a user plane protocol stack of NR, and FIG. 6-(b) shows a control plane protocol stack of NR.

Hereinafter, a sidelink synchronization signal (SLSS) and synchronization information will be described.

The SLSS is an SL-specific sequence, and may include a primary sidelink synchronization signal (PSSS) and a secondary sidelink synchronization signal (SSSS). The PSSS may be referred to as a sidelink primary synchronization signal (S-PSS), and the SSSS may be referred to as a sidelink secondary synchronization signal (S-SSS). For example, length-127 M-sequences may be used for the S-PSS, and length-127 gold sequences may be used for the S-SSS. For example, the UE may detect an initial signal and acquire synchronization using the S-PSS. For example, the UE may acquire detailed synchronization using the S-PSS and the S-SSS, and may detect a synchronization signal ID.

A physical sidelink broadcast channel (PSBCH) may be a (broadcast) channel on which basic (system) information that the UE needs to know first before transmission and reception of an SL signal is transmitted. For example, the basic information may include SLSS related information, a duplex mode (DM), time division duplex uplink/downlink (TDD UL/DL) configuration, resource pool related information, the type of an application related to the SLSS, a subframe offset, and broadcast information. For example, for evaluation of PSBCH performance, the payload size of PSBCH in NR V2X may be 56 bits including CRC of 24 bits.

The S-PSS, S-SSS, and PSBCH may be included in a block format (e.g., an SL synchronization signal (SS)/PSBCH block, hereinafter sidelink-synchronization signal block (S-SSB)) supporting periodic transmission. The S-SSB may have the same numerology (i.e., SCS and CP length) as a physical sidelink control channel (PSCCH)/physical sidelink shared channel (PSSCH) in the carrier, and the transmission bandwidth thereof may be within a (pre) set sidelink BWP (SL BWP). For example, the bandwidth of the S-SSB may be 11 resource blocks (RBs). For example, the PSBCH may span 11 RBs. The frequency position of the S-SSB may be (pre) set. Accordingly, the UE does not need to perform hypothesis detection at a frequency to discover the S-SSB in the carrier.

In the NR SL system, a plurality of numerologies having different SCSs and/or CP lengths may be supported. In this case, as the SCS increases, the length of the time resource in which the transmitting UE transmits the S-SSB may be shortened. Thereby, the coverage of the S-SSB may be narrowed. Accordingly, in order to guarantee the coverage of the S-SSB, the transmitting UE may transmit one or more S-SSBs to the receiving UE within one S-SSB transmission period according to the SCS. For example, the number of S-SSBs that the transmitting UE transmits to the receiving UE within one S-SSB transmission period may be pre-configured or configured for the transmitting UE. For example, the S-SSB transmission period may be 160 ms. For example, for all SCSs, the S-SSB transmission period of 160 ms may be supported.

For example, when the SCS is 15 kHz in FR1, the transmitting UE may transmit one or two S-SSBs to the receiving UE within one S-SSB transmission period. For example, when the SCS is 30 kHz in FR1, the transmitting UE may transmit one or two S-SSBs to the receiving UE within one S-SSB transmission period. For example, when the SCS is 60 kHz in FR1, the transmitting UE may transmit one, two, or four S-SSBs to the receiving UE within one S-SSB transmission period.

For example, when the SCS is 60 kHz in FR2, the transmitting UE may transmit 1, 2, 4, 8, 16 or 32 S-SSBs to the receiving UE within one S-SSB transmission period. For example, when SCS is 120 kHz in FR2, the transmitting UE may transmit 1, 2, 4, 8, 16, 32 or 64 S-SSBs to the receiving UE within one S-SSB transmission period.

When the SCS is 60 kHz, two types of CPs may be supported. In addition, the structure of the S-SSB transmitted from the transmitting UE to the receiving UE may depend on the CP type. For example, the CP type may be normal CP (NCP) or extended CP (ECP). Specifically, for example, when the CP type is NCP, the number of symbols to which the PSBCH is mapped in the S-SSB transmitted by the transmitting UE may be 9 or 8. On the other hand, for example, when the CP type is ECP, the number of symbols to which the PSBCH is mapped in the S-SSB transmitted by the transmitting UE may be 7 or 6. For example, the PSBCH may be mapped to the first symbol in the S-SSB transmitted by the transmitting UE. For example, upon receiving the S-SSB, the receiving UE may perform an automatic gain control (AGC) operation in the period of the first symbol for the S-SSB.

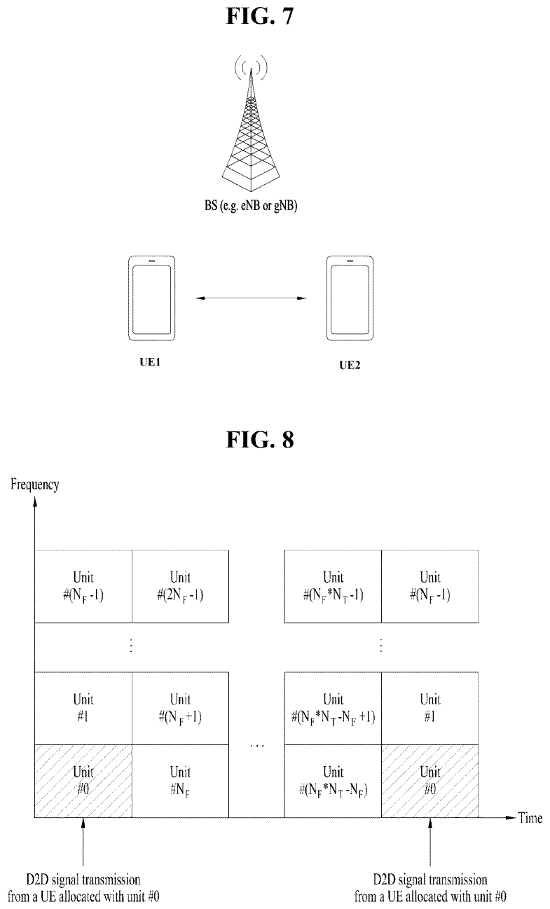

FIG. 7 illustrates UEs performing V2X or SL communication.

Referring to FIG. 7, in V2X or SL communication, the term UE may mainly refer to a user's UE. However, when network equipment such as a BS transmits and receives signals according to a communication scheme between UEs, the BS may also be regarded as a kind of UE. For example, UE 1 may be the first device 100, and UE 2 may be the second device 200.

For example, UE 1 may select a resource unit corresponding to a specific resource in a resource pool, which represents a set of resources. Then, UE 1 may transmit an SL signal through the resource unit. For example, UE 2, which is a receiving UE, may receive a configuration of a resource pool in which UE 1 may transmit a signal, and may detect a signal of UE 1 in the resource pool.

Here, when UE 1 is within the connection range of the BS, the BS may inform UE 1 of a resource pool. On the other hand, when the UE 1 is outside the connection range of the BS, another UE may inform UE 1 of the resource pool, or UE 1 may use a preconfigured resource pool.

In general, the resource pool may be composed of a plurality of resource units, and each UE may select one or multiple resource units and transmit an SL signal through the selected units.

FIG. 8 illustrates resource units for V2X or SL communication.

Referring to FIG. 8, the frequency resources of a resource pool may be divided into NF sets, and the time resources of the resource pool may be divided into NT sets. Accordingly, a total of NF*NT resource units may be defined in the resource pool. FIG. 8 shows an exemplary case where the resource pool is repeated with a periodicity of NT subframes.

As shown in FIG. 8, one resource unit (e.g., Unit #0) may appear periodically and repeatedly. Alternatively, in order to obtain a diversity effect in the time or frequency dimension, an index of a physical resource unit to which one logical resource unit is mapped may change in a predetermined pattern over time. In this structure of resource units, the resource pool may represent a set of resource units available to a UE which intends to transmit an SL signal.

Resource pools may be subdivided into several types. For example, according to the content in the SL signal transmitted in each resource pool, the resource pools may be divided as follows.

(1) Scheduling assignment (SA) may be a signal including information such as a position of a resource through which a transmitting UE transmits an SL data channel, a modulation and coding scheme (MCS) or multiple input multiple output (MIMO) transmission scheme required for demodulation of other data channels, and timing advance (TA). The SA may be multiplexed with SL data and transmitted through the same resource unit. In this case, an SA resource pool may represent a resource pool in which SA is multiplexed with SL data and transmitted. The SA may be referred to as an SL control channel.

(2) SL data channel (physical sidelink shared channel (PSSCH)) may be a resource pool through which the transmitting UE transmits user data. When the SA and SL data are multiplexed and transmitted together in the same resource unit, only the SL data channel except for the SA information may be transmitted in the resource pool for the SL data channel. In other words, resource elements (REs) used to transmit the SA information in individual resource units in the SA resource pool may still be used to transmit the SL data in the resource pool of the SL data channel. For example, the transmitting UE may map the PSSCH to consecutive PRBs and transmit the same.

(3) The discovery channel may be a resource pool used for the transmitting UE to transmit information such as the ID thereof. Through this channel, the transmitting UE may allow a neighboring UE to discover the transmitting UE.

Even when the SL signals described above have the same content, they may use different resource pools according to the transmission/reception properties of the SL signals. For example, even when the SL data channel or discovery message is the same among the signals, it may be classified into different resource pools according to determination of the SL signal transmission timing (e.g., transmission at the reception time of the synchronization reference signal or transmission by applying a predetermined TA at the reception time), a resource allocation scheme (e.g., the BS designates individual signal transmission resources to individual transmitting UEs or individual transmission UEs select individual signal transmission resources within the resource pool), signal format (e.g., the number of symbols occupied by each SL signal in a subframe, or the number of subframes used for transmission of one SL signal), signal strength from a BS, the strength of transmit power of an SL UE, and the like.

### <Stepwise Transmission of Sensor-Recognized Detection Information>

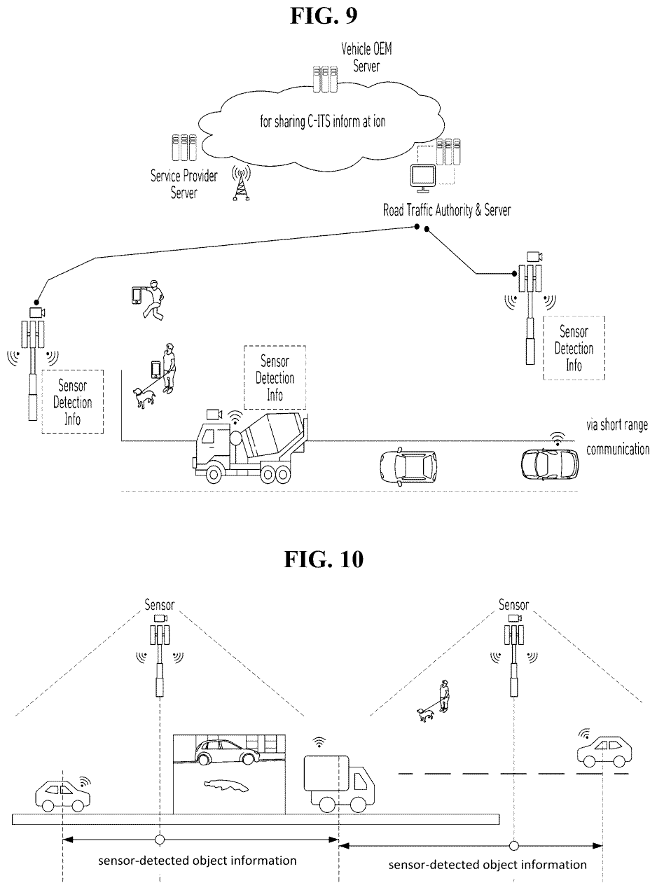

FIG. 9 is a diagram illustrating transmission of sensor-recognized detection information from a conventional ITS station.

According to the conventional technology, when ITS stations (e.g., RSUs, vehicles, or the like) are equipped with a sensor, each ITS station does not directly transmit high-definition (HD) data before its own sensor recognizes and analyzes it. Instead, it configures a V2X message with information about objects detected from the HD data and transmits sensor-recognized information to neighboring ITS stations, thereby reducing the amount of data required for transmission.

When an ITS station, which is equipped with a sensor and transmits object detection information recognized by the sensor and analyzed, broadcasts a corresponding message, ITS stations (e.g., OBUs, vehicle ITS stations, or VRUs) passing near the ITS station transmitting the message receive the V2X message.

Each sensor mounted on ITS station(s) may have different recognition and detection capabilities, and also a different capability of analyzing detected HD data. Therefore, the object information included in the message transmitted from the ITS station may vary depending on the recognition and detection capability and HD data analysis capability of the sensor mounted on the ITS station.

An ITS station that passes near the transmitting ITS station and receives the message may trust analysis information about an object included in the received V2X message and predict a collision risk based on the information. However, the receiving ITS station has a problem in that it may not know errors or information reduction that may occur in the process of analyzing/processing the information about the object in the transmitting ITS station.

To solve the problem, a method for preventing a collision risk and providing V2X data efficiently through stepwise transmission/reception of a sensor-detected V2X message is proposed according to the disclosure.

Specifically, in a situation where a transmitting ITS station has to provide HD data before analysis (hereinafter, unprocessed HD data) with priority or a receiving ITS station is capable of using the unprocessed HD data, the unprocessed HD data is transmitted to maintain a traffic flow more efficiently and prevent a collision risk, while minimizing the increase in the amount of transmitted and received data. When the situation where the transmitting ITS station provides unprocessed HD data is released, the transmitting ITS station configures a V2X message with analyzed information and transmits the V2X message. Alternatively, when any receiving ITS station requests the HD data stored in the transmitting ITS station, the transmitting ITS station may unicast the unprocessed HD data only to that ITS station.

For the proposed stepwise configuration of a sensor-detected V2X message, a method in which an ITS station transmitting a V2X message configures the V2X message by receiving information that may be included in the V2X message in various manners may be considered.

FIG. 10 illustrates an example in which an ITS station equipped with a sensor provides information to neighboring ITS stations. For example, a first ITS station equipped with a sensor may detect object information from HD data acquired by the sensor and configure a V2X message with the object information by analyzing the object information. The detection of the object information may relate to, for example, a road pothole situation or a situation where a VRU object intending to cross a road is analyzed. The first ITS station may provide the V2X message to its neighboring second ITS station.

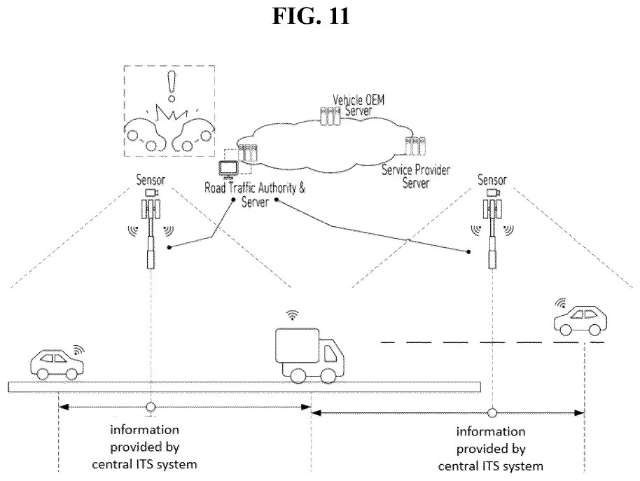

FIG. 11 illustrates an example in which an RSU connected to a central ITS provides road condition information to a neighboring approaching vehicle or ITS station. The central ITS (e.g., road traffic authority) may provide the road condition information (e.g., planned road construction information or sudden accident information) to the RSU connected to the central ITS. The RSU may configure a V2X message with the road condition information and provide it to a neighboring approaching vehicle or ITS station.

Hereinbelow, an ITS station, which receives information from a sensor or the central ITS and then transmits the information by analyzing it, configures a V2X message with object information by analyzing the object information and transmits the V2X message to a passing vehicle station or VRU station, and when a proposed specific situation occurs, the ITS station may transmit unprocessed HD data together. A stepwise sensor detection information transmission method and apparatus are proposed in which when the situation is released, object information analyzed through sensor recognition is transmitted again.

### Case 1

A transmitting ITS station equipped with a sensor transmits sensor-recognized detection information in a V2X message by analyzing it. Since the capability of detecting an object from unprocessed HD data recognized by the sensor varies depending on the capabilities of the transmitting ITS station, the following situations may occur.
A situation where the transmitting ITS station detects a specific object through sensor recognition but may not include it in the V2X message because the confidence in the detection information is low, or a situation where the transmitting ITS station analyzes that there is a collision risk due to the detected object.
A case where a dynamic object is detected even though it was not detected by the sensor (a bounding box is drawn around a part detected in the unprocessed HD data, but it is impossible to classify it with the detection capability of the transmitting ITS station, for example, an obstacle such as fallen cargo/spare tire is analyzed as moving on the road).

When the above situation occurs, the transmitting ITS station may configure and transmit a V2X message using the HD data recognized by the sensor, as follows.

TABLE 5

```
DetectedObjectList::= SEQUENCE (SIZE(1..256)) OF DetectedObjectData
  DetectedObjectData::= SEQUENCE {
    detObjCommon DetectedObjectCommonData → (a)
    -- Common data for detected object
    detObjOptData DetectedObjectOptionalData OPTIONAL → (b)
    -- Type specific optional data
    }
DetectedObjectCommonData::= SEQUENCE {
    objType ObjectType, → (c)
    objTypeCfd ClassificationConfidence,
    objectID ObjectID,
    -- temporary ID assigned by source
    measurementTime MeasurementTimeOffset,
    -- Detection time
    timeConfidence TimeConfidence,
    pos PositionOffsetXYZ,
    posConfidence PositionConfidenceSet,
    speed Speed,
    speedConfidence SpeedConfidence,
    speedZ Speed OPTIONAL,
    speedConfidenceZ SpeedConfidence OPTIONAL,
    heading Heading,
    headingConf HeadingConfidence,
    accel4way AccelerationSet4Way OPTIONAL,
    accCfdX AccelerationConfidence OPTIONAL,
    accCfdY AccelerationConfidence OPTIONAL,
    accCfdZ AccelerationConfidence OPTIONAL,
    accCfdYaw YawRateConfidence OPTIONAL,
    beConflicted BeConflicted OPTIONAL, → (d)
    conflictedObjID ConflictedObjID OPTIONAL → (e)
    ...
}
ObjectType::= ENUMERATED{
    unknown (0),
    vehicle (1),
    vru (2),
    animal (3),
    ...
}
ClassificationConfidence ::= INTEGER (0..101)
BeConflicted ::= ENUMERATED{
    Undefined (0),
    objectInfoFromOther (1),
    CentralSystemInfo (2),
    ...
}
ConflictedObjectID ::= INTEGER (0..65535)
```

Regarding (a) a detObjCommon DetectedObjectCommonData parameter in Table 5, reference is made to the following description. (b) detObjOptData DetectedObjectOptionalData may be optionally used, when an object type is Vehicle/VRU/animal. (c) Sensor detection information of the transmitting ITS station is entered in an ObjectType parameter of objType. (d) A BeConflicted parameter of beConflicted is set to (1) or (2). (e) A ConflictedObjID parameter of conflictedObjID is set to the value of objectID included in another V2X message.

Although the transmitting ITS station writes the result of analyzing a sensor-recognized detected object as unknown in the V2X message, it may transmit HD data (snap shot or streaming video) as auxiliary information to help the receiving ITS station identify it.

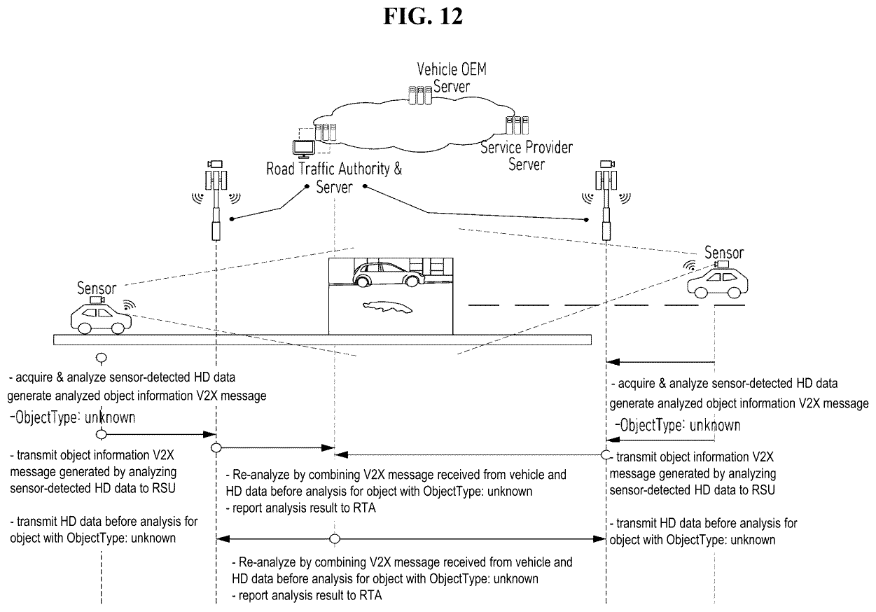

FIG. 12 illustrates an example of a case where a proposal for Case 1 is implemented. Referring to FIG. 12, when Case 1 occurs, vehicles equipped with sensors may transmit information acquired through the sensors and unprocessed HD data together to an RSU. The RSU may collect road condition information through a connected network, transmit it to a server responsible for a management function such as an RTA to strengthen the road management function, and share the information with other vehicles.

### Case 2

A transmitting ITS station equipped with a sensor analyzes sensor-recognized detection information and transmits it in a V2X message. Since the capability of detecting an object from unprocessed HD data recognized by the sensor varies depending on the capabilities of the transmitting ITS station, it may receive a V2X message including object information analyzed by another ITS station equipped with a sensor. This object information may be different from the object information included in the V2X message that the transmitting ITS station configures and transmits. Further, it may be different from the result of analyzing a planned road condition (e.g., a construction zone or a traffic accident status) shared with the central ITS station and the data recognized by the sensor of the transmitting ITS station.

For example, object information acquired by analyzing HD data recognized through a sensor in a vehicle or RSU equipped with the sensor may be inconsistent with information received from a central ITS station or another ITS station equipped with a sensor.

When such a situation occurs, the ITS station (vehicle or RSU) equipped with the sensor may configure a V2X message with its sensor detection result data, as follows.

In a situation where Case 2 occurs, the transmitting ITS station describes an object type and additional information based on an analysis result of its own sensor-recognized HD data in a common data part of Detected object data of the configured V2X message, and may include additional information about other conflicting object information included in other messages or conflicting information transmitted to the central ITS in the V2X message.

```
TABLE 6
  DetectedObjectList::= SEQUENCE (SIZE(1..256)) OF DetectedObjectData
    DetectedObjectData::= SEQUENCE {
    detObjCommon DetectedObjectCommonData, → (a)
    -- Common data for detected object
    detObjOptData DetectedObjectOptionalData OPTIONAL → (b)
    -- Type specific optional data
    }
DetectedObjectCommonData::= SEQUENCE {
    objType ObjectType, → (c)
    objTypeCfd ClassificationConfidence,
    objectID ObjectID,
    -- temporary ID assigned by source
    measurementTime MeasurementTimeOffset,
    -- Detection time
    timeConfidence TimeConfidence,
    pos PositionOffsetXYZ,
    posConfidence PositionConfidenceSet,
    speed Speed,
    speedConfidence SpeedConfidence,
    speedZ Speed OPTIONAL,
    speedConfidenceZ SpeedConfidence OPTIONAL,
    heading Heading,
    headingConf HeadingConfidence,
    accel4way AccelerationSet4Way OPTIONAL,
    accCfdX AccelerationConfidence OPTIONAL,
    accCfdY AccelerationConfidence OPTIONAL,
    accCfdZ AccelerationConfidence OPTIONAL,
    accCfdYaw YawRateConfidence OPTIONAL,
    beConflicted BeConflicted OPTIONAL, → (d)
    conflictedObjID ConflictedObjID OPTIONAL, → (e)
    ...
  }
  ObjectType::= ENUMERATED{
    unknown (0),
    vehicle (1),
    vru (2),
    animal (3),
    ...
  }
  ClassificationConfidence ::= INTEGER (0..101)
  BeConflicted ::= ENUMERATED{
    Undefined (0),
    objectInfoFromOther (1),
    CentralSystemInfo (2),
    ...
  }
  ConflictedObjectID ::= INTEGER (0..65535)
```

(a) A detObjCommon DetectedObjectCommonData parameter in Table 6 will be described below in detail. (b) A detObjOptData DetectedObjectOptionalData parameter may be optionally used, when an object type is Vehicle/VRU/animal. (c) Sensor detection information of the transmitting ITS station is entered in an ObjectType parameter of objType. (d) A BeConflicted parameter of beConflicted is set to (1) or (2). (e) A ConflictedObjID parameter of conflictedObjID is set to the value of objectID included in another V2X message.

An example of implementing a proposal for Case 2 is as follows.

When Case 2 occurs, vehicles equipped with sensors transmit object information analyzed using their own sensors together with unprocessed HD data to the central ITS station. The central ITS station may update information that it provided by re-analyzing and reviewing the HD data or guide function update to the vehicles/RSUs that transmitted the conflicting object analysis information.

### Case 3

A method is proposed in which when a high-priority situation requiring inclusion of unprocessed HD data occurs, a transmitting ITS station transmits analyzed object information together with unprocessed HD data, and an ITS station receiving the unprocessed HD data is allowed to analyze the data. The high-priority situation is defined as follows. When the following situations occur, a V2X message with analyzed sensor detection information and HD data before the analysis may be transmitted together, so that the receiving ITS station may acquire more accurate information.
A case where an emergency vehicle approaches with an emergency signal: in the case where an emergency vehicle (a fire truck or an ambulance) passes in an emergency situation, when a receiving vehicle checks HD data to identify a direction and lane in which the emergency vehicle is coming, it may take a preemptive action to yield.
A case where a sensor recognizes exposure of a VRU on a highway (e.g., a situation where people are outside a car in a traffic accident).

The transmitting ITS station may select a method of providing unprocessed HD data recognized through the sensor by considering various factors such as a communication environment where transmitting and receiving ends are connected, and the type (e.g., vehicle, RSU, VRU, and so on) and capability of the transmitting/receiving ITS station.

When a communication environment is used based on V2N, the transmitting ITS station and the receiving ITS station perform a service set-up process first, when using a sensor-recognized information service. Herein, ITS stations connected based on V2N communication may set factors that may affect determination of a method of transmitting/receiving unprocessed HD data.

1) The transmitting ITS station may set conditions, when uploading unprocessed HD data to a server connected to a network.
Whether the transmitting ITS station will bear the amount of data consumption required for the transmission of unprocessed HD data.
A condition for additionally uploading HD data (e.g., when including an unknown object in object recognition information after analysis, when analysis results conflict, when a high-priority situation occurs, or the like).

2) The receiving ITS station may set conditions for receiving unprocessed HD data acquired by the server through the network connected to the server.
Whether the receiving ITS station will bear the amount of data consumption required for the transmission of unprocessed HD data.
A condition under which the transmitting ITS station additionally transmits HD data to the receiving ITS station may be set. For example, it may be inclusion of an unknown object in object recognition information after analysis, conflicting analysis results, occurrence of a high-priority situation, or the like.
The condition for additionally transmitting HD data may be further detailed (e.g., conditions such as when the object recognition information after analysis includes an unknown object and the unknown object is located at a distance equal to or less than a specific value, when the moving speed of the object is equal to or higher than a specific value, when the size of the object is equal to or greater than a specific value, and so on).

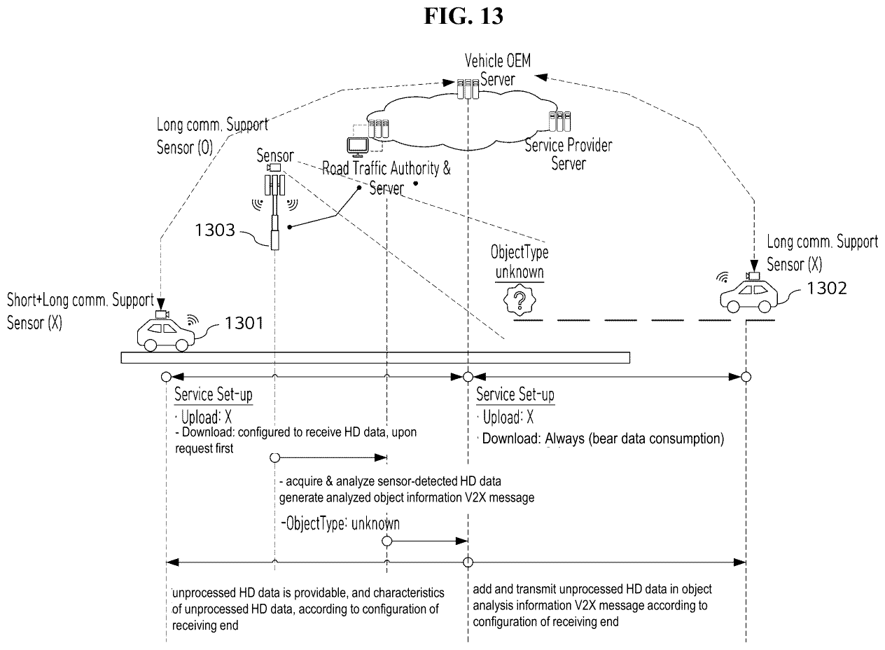

FIG. 13 is a diagram illustrating service set-up of receiving ITS stations. Referring to FIG. 13, a receiving ITS station 1301 performs service set-up such that it does not perform upload, and receives HD data by download only when it requests HD data from a network. A receiving ITS station 1302 performs service set-up such that it does not perform upload, and always receives HD data by download. A sensor 1303 may generate a V2X message by acquiring and analyzing sensor-detected HD data. It is assumed that the type of the detected object is unknown object. According to reception of the V2X message for the unknown object, the network may notify the receiving ITS station 1301 that unprocessed HD data may be provided, and transmit unprocessed HD data characteristic information. Upon request of the receiving ITS station 1301, the network provides the unprocessed HD data to the receiving ITS station 1301. According to the reception of the V2X message, the network may provide a V2X message including the unprocessed HD data to the receiving ITS station 1302.

According to an embodiment, the transmitting ITS station may additionally transmit unprocessed HD data in one of the following methods, and may select this method.

1. The transmitting ITS station broadcasts unprocessed HD data together with processed data (object analysis information).
When an unknown object is detected and additional conditions are satisfied, the transmitting ITS station may automatically transmit the unprocessed HD data.
The transmitting ITS station may include the unprocessed HD data in a V2X message.
The transmitting ITS station may include access information (an access address, authorization, HD data attributes (streaming video/snap shot), and expiration) for receiving the unprocessed HD data, in the V2X message.

2. When the transmitting ITS station first notifies that the unprocessed HD data is available, the receiving ITS station may individually request and receive the unprocessed HD data in a unicast method. The transmitting ITS station may unicast the unprocessed HD data to each of requesting receiving ITS stations or share the access address and authorization for receiving a streaming video or a snapshot in HD data request available information, so that the receiving ITS station may acquire the HD data.

The unprocessed HD data acquired through the sensor may have a large data size and be usable only in an ITS station having the capability of analyzing this data. Therefore, even if the situation defined in the disclosure occurs and unprocessed HD data may also be provided, the transmitting ITS station may first provide information that it may provide the HD data upon request, along with main characteristics of the HD data. Thereafter, when the receiving ITS station that has received this information checks its own capability and the possibility of analyzing the HD data and then requests the unprocessed HD data from the transmitting ITS station, the unprocessed HD data may be provided.

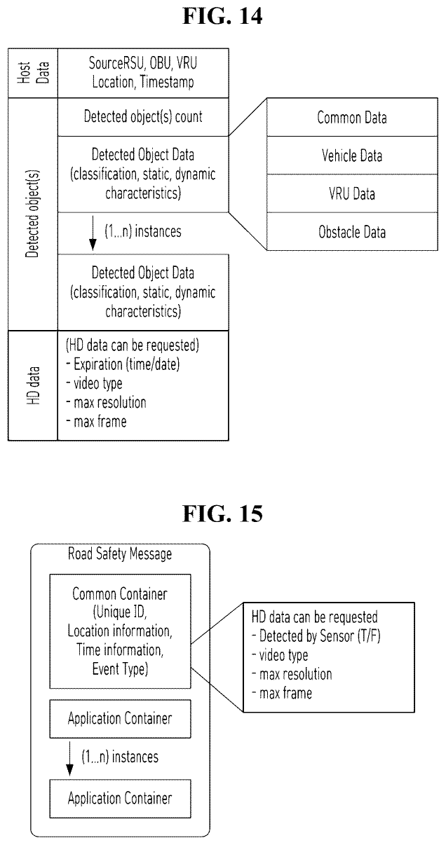

An SDSM including sensor-recognized object detection information may also provide the unprocessed HD data. For example, as illustrated in FIG. 14, the unprocessed HD data may be additionally included in the SDSM.

In the case of the SDSM, since it is assumed that all information included in the message is information detected by the sensor, it does not include a field indicating whether this information was detected by the sensor or provided from some other system.

When the receiving ITS station requests the HD data, the SDSM may include at least part of the following information.
Expiration: This refers to a valid period during which the unprocessed HD data may be requested. Since the HD data acquired by the sensor may not be stored indefinitely, this indicates how long the transmitting ITS station will manage this HD data and transmit it upon request. An ITS station that has received sensor-recognized object information and HD data request-related information together may transmit a related HD data request along with a V2X message ID within the expiration period.
Video type: This refers to a video type related to whether the HD data related to the object may be provided as a snapshot image or a short video clip.
Max resolution: This refers to a maximum resolution at which the HD data may be provided.
Max frame: When the video type is video rather than image, this refers to a maximum number of frames in the video.

An RSU may provide a road safety message (RSM) including safety-related information that may occur on the road. The RSM may include HD data information that may be requested. FIG. 15 illustrates an example of an RSM.

Unlike an SDSM, an RSM may be configured to include information received from various sources as well as object information detected by a sensor. Accordingly, the RSM may also include information indicating whether the corresponding information has been recognized/detected by the sensor.

According to an embodiment, a method is proposed in which an ITS station that has received an SDSM or RSM notifying that HD data may be requested requests unprocessed HD data before analysis, as follows.

Since unprocessed HD data consumes a large amount of bandwidth for transmission and reception, the receiving ITS station may request only necessary partial data (video). The receiving ITS station may transmit an HD data Request Message to indicate information about HD data to be received. The HD data Request Message may be configured based on HD data request available information received by the receiving ITS station.

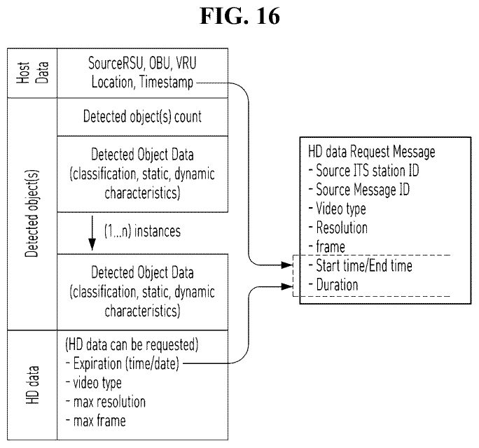

FIG. 16 illustrates an example of an HD data Request Message.

In FIG. 16, the HD data Request Message may be configured as follows.
Source ITS station ID: Source RSU (OBU or VRU) ID of the SDSM (RSM)
Source message ID: Message ID of the SDSM (RSM)
Video type: This may be video or still image. When the video type is video, a resolution/frame value may be determined and included in the HD data Request Message.
Start time/End time: When the video type is video, a video before an expiration period for requesting HD data based on a time stamp recorded in the SDSM (RSM) may be requested.
Duration: When the start time is specified, the length of the video may be indicated by the duration to determine the length of the video and request the video.

When the situation where unprocessed HD data may be provided ends, the transmitting ITS station may delete HD data-related information (e.g., HD data request available information or the HD data itself) from the V2X message, and configure and transmit a V2X message including only object information detected and analyzed through sensor recognition as is usually done.

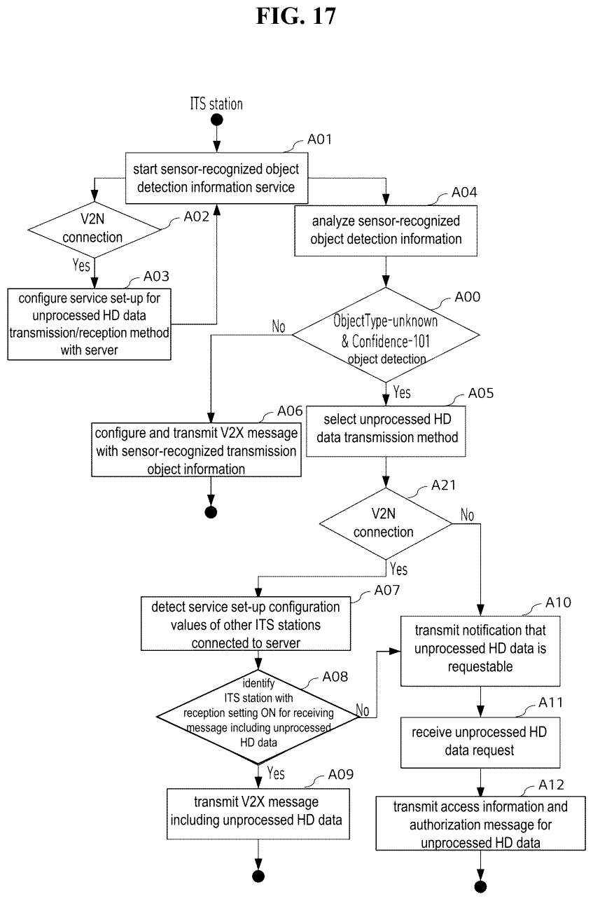

FIG. 17 illustrates an operation of a transmitting ITS station according to an embodiment.

Referring to FIG. 17, the transmitting ITS station starts a sensor-recognized/detected object information service (A01). When connected to a V2N network, the transmitting ITS station performs a service set-up configuration for an unprocessed HD data transmission/reception method with a server (A03).

The transmitting ITS station analyzes object information recognized/detected through a sensor (A04).

When the type of a detected object is unknown and confidence is a specific value (e.g., 101) as a result of the analysis, the transmitting ITS station may determine to transmit unprocessed HD data and select a transmission method for the unprocessed HD data (A05). Otherwise, the transmitting ITS station may generate/transmit a V2X message based on the analysis result (A06).

When the transmitting ITS station is connected to the V2N network, the transmitting ITS station acquires service set-up configuration values of receiving ITS stations connected to a server (A07), identifies a receiving ITS station configured to receive the unprocessed HD data among them (A08), and transmits the unprocessed HD data (A09).

The transmitting ITS station may transmit a notification message notifying that the unprocessed HD data may be provided upon request (A10). When the transmitting ITS station receives an unprocessed HD data request message from a receiving ITS station (A11), it may transmit an access information and authorization message for the unprocessed HD data (A12).

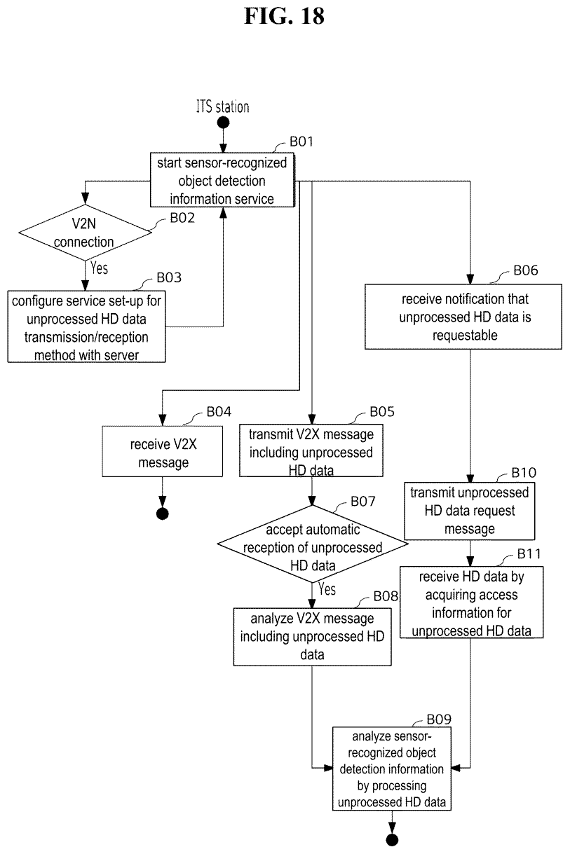

FIG. 18 illustrates an operation of a receiving ITS station according to an embodiment.

Referring to FIG. 18, the receiving ITS station starts a sensor-recognized/detected object information service (B01). When connected to a V2N network, the receiving ITS station performs a service set-up configuration for an unprocessed HD data transmission/reception methods with a server (B03).

According to the service set-up configuration, the receiving ITS station may receive a V2X message (not including unprocessed HD data) (B04), a V2X message including the unprocessed HD data (B05), or a notification message notifying that the unprocessed HD data may be provided upon request (B06).

The receiving ITS station may acquire the unprocessed HD data by accepting automatic reception of unprocessed HD data (B07). The receiving ITS station may analyze the V2X message including the unprocessed HD data (B08), and process the unprocessed HD data to analyze sensor-recognized/detected object information (B09).

When the receiving ITS station receives the notification message notifying that the unprocessed HD data may be provided (B06), the receiving ITS station may request the unprocessed HD data from a transmitting ITS station (B10). The receiving ITS station may acquire information for accessing the unprocessed HD data from the transmitting ITS station and receive the unprocessed HD data using this information (B11).

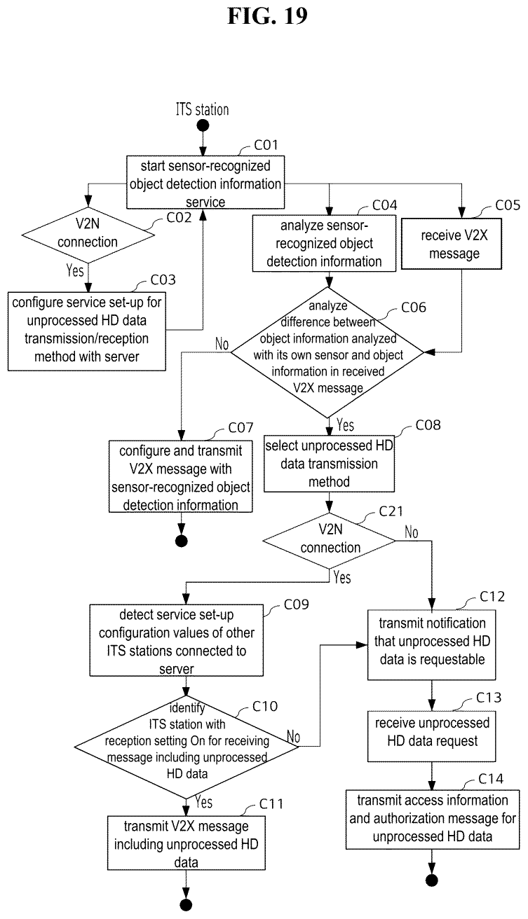

FIG. 19 illustrates an operation of an ITS station according to an embodiment.

Referring to FIG. 19, the ITS station starts a sensor-recognized/detected object information service (C01). When connected to a V2N network, the ITS station performs a service set-up configuration for an unprocessed HD data transmission/reception method with a server (C03).

The ITS station analyzes object information recognized/detected through a sensor (C04).

The ITS station may receive a V2X message from another ITS station or a network (C05).

The ITS station determines the difference between the object information analyzed by it and object information included in the received V2X message (C06). When the difference is less than a specific value, the ITS station transmits a sensor-recognized/detected object information V2X message (not including unprocessed HD data) (C07). When the difference is equal to or greater than the specific value, the ITS station may determine to transmit unprocessed HD data and select an unprocessed HD data transmission method (C08).

When the ITS station is connected to the V2N network, the ITS station acquires service set-up configuration values of receiving ITS stations connected to a server (C09), identifies a receiving ITS station configured to receive the unprocessed HD data among them (C10), and transmits the unprocessed HD data (C11).

The ITS station may transmit a notification message notifying that the unprocessed HD data may be provided upon request (C12). When the ITS station receives an unprocessed HD data request message from a receiving ITS station (C13), it may transmit an access information and authorization message for the unprocessed HD data (C14).

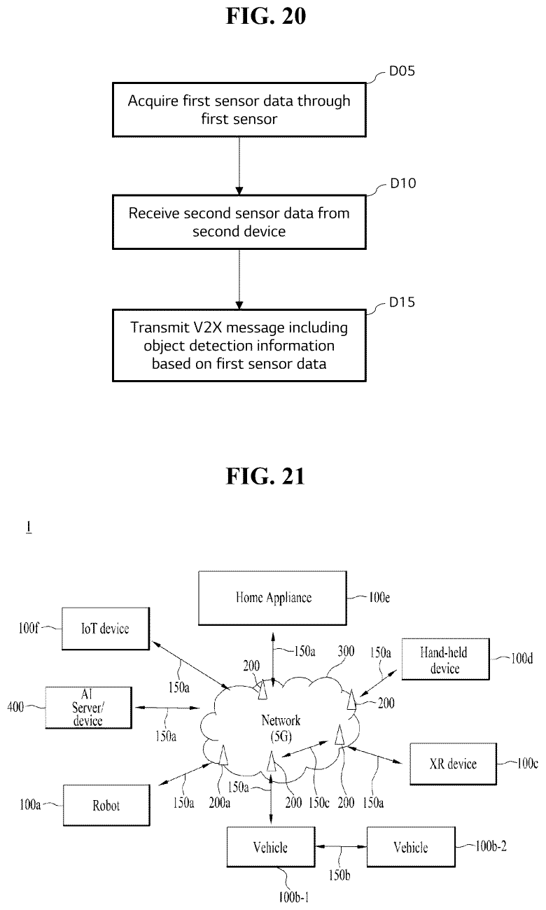

FIG. 20 illustrates a flowchart illustrating a method for transmitting a signal by a first device in an ITS according to an embodiment. The first device may be a transmitting ITS station.

The first device may acquire first sensor data through a first sensor (D05).

The first device may receive second sensor data detected through a second sensor different from the first sensor from a second device (D10).

The first device may transmit a V2X message including object detection information based on the first sensor data (D15).

The first device may determine the object detection information included in the V2X message, based on whether the first sensor data conflicts with the second sensor data.

Based on that the first sensor data conflicts with the second sensor data, the object detection information may include information about HD data of the first sensor data, which is not processed by the first device. The information about the HD data may include address information for accessing the HD data. The information about the HD data may include at least one of valid time information, video type information, maximum resolution information, or maximum frame number information, about the HD data.

Based on that the first sensor data does not conflict with the second sensor data, the first device may configure the object detection information by processing the first sensor data.

The V2X message may include information about a type of the second device providing the second sensor data. The type of the second device may relate to whether the second device is a road side unit (RSU) or a central-intelligent transportation system (C-ITS) server.

Based on that a confidence level for an object detected through the first sensor is less than a threshold, the object detection information may include information about HD data of the first sensor data, which is not processed by the first device.

Based on that an object that cannot be identified by the first device is detected through the first sensor, the object detection information may include information about HD data of the first sensor data, which is not processed by the first device.

Based on that a predefined emergency situation occurs, the object detection information may include information about HD data of the first sensor data, which is not processed by the first device.

Although not limited thereto, various descriptions, functions, procedures, proposals, methods, and/or operational flow charts of the present disclosure disclosed in this document may be applied to various fields requiring wireless communication/connection (5G) between devices.

Hereinafter, it will be illustrated in more detail with reference to the drawings. In the following drawings/description, the same reference numerals may exemplify the same or corresponding hardware blocks, software blocks, or functional blocks, unless otherwise indicated.

FIG. 21 illustrates a communication system applied to the present disclosure.

Referring to FIG. 21, a communication system 1 applied to the present disclosure includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an extended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g., relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

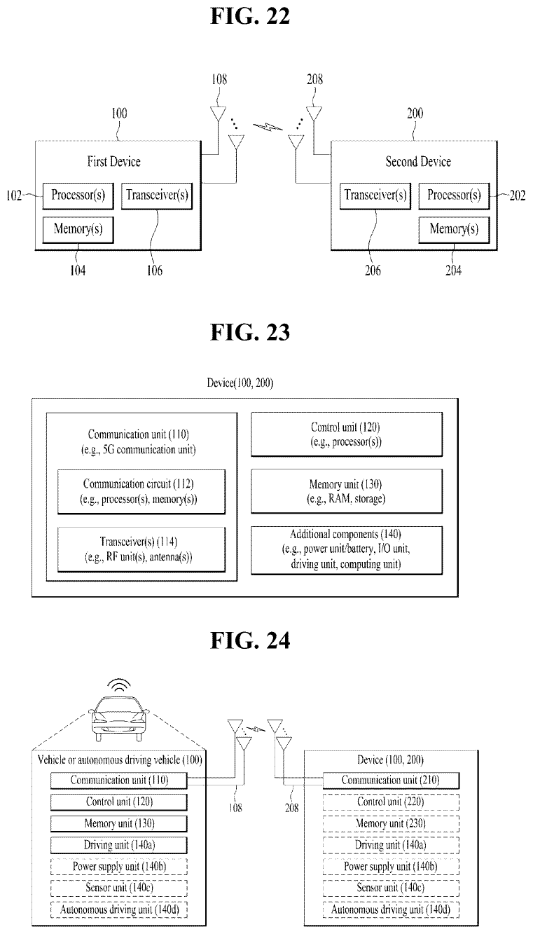

FIG. 22 illustrates a wireless device applicable to the present disclosure.

Referring to FIG. 22, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 21.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information acquired by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document.

Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

Specifically, a UE may include the processor(s) 102 connected to the RF transceiver and the memory(s) 104. The memory(s) 104 may include at least one program for performing operations related to the embodiments described above with reference to FIGS. 11 to 27.

Alternatively, a chipset including the processor(s) 102 and memory(s) 104 may be configured. The chipset may include: at least one processor; and at least one memory operably connected to the at least one processor and configured to, when executed, cause the at least one processor to perform operations.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information acquired by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

FIG. 23 illustrates another example of a wireless device applied to the present disclosure. The wireless device may be implemented in various forms according to a use-case/service (refer to FIG. 21)

Referring to FIG. 23, wireless devices 100 and 200 may correspond to the wireless devices 100 and 200 of FIG. 22 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 22. For example, the transceiver(s) 114 may include the one or more transceivers 106 and 206 and/or the one or more antennas 108 and 208 of FIG. 22. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 21), the vehicles (100b-1 and 100b-2 of FIG. 21), the XR device (100c of FIG. 21), the hand-held device (100d of FIG. 21), the home appliance (100e of FIG. 21), the IoT device (100f of FIG. 21), a digital broadcast terminal, a hologram device, a public safety device, an MTC device, a medicine device, a fintech device (or a finance device), a security device, a climate/environment device, the AI server/device (400 of FIG. 21), the BSs (200 of FIG. 21), a network node, etc. The wireless device may be used in a mobile or fixed place according to a use-example/service.

In FIG. 23, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

FIG. 24 illustrates a vehicle or an autonomous driving vehicle applied to the present disclosure. The vehicle or autonomous driving vehicle may be implemented by a mobile robot, a car, a train, a manned/unmanned Aerial Vehicle (AV), a ship, etc.

Referring to FIG. 24, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 23, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an Electronic Control Unit (ECU). Also, the driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the acquired data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly acquired data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

Here, wireless communication technologies implemented in the wireless devices (XXX, YYY) of the present specification may include LTE, NR, and 6G, as well as Narrowband Internet of Things for low power communication. At this time, for example, the NB-IoT technology may be an example of a Low Power Wide Area Network (LPWAN) technology, and may be implemented in standards such as LTE Cat NB1 and/or LTE Cat NB2, and is not limited to the above-described names. Additionally or alternatively, the wireless communication technology implemented in the wireless devices (XXX, YYY) of the present specification may perform communication based on LTE-M technology. In this case, as an example, the LTE-M technology may be an example of LPWAN technology, and may be referred to by various names such as eMTC (enhanced machine type communication). For example, LTE-M technology may be implemented in at least one of a variety of standards, such as 1) LTE CAT 0, 2) LTE Cat M1, 3) LTE Cat M2, 4) LTE non-BL (non-Bandwidth Limited), 5) LTE-MTC, 6) LTE Machine Type Communication, and/or 7) LTE M, and is not limited to the above-described names. Additionally or alternatively, the wireless communication technology implemented in the wireless devices (XXX, YYY) of the present specification is at least one of ZigBee, Bluetooth, and Low Power Wide Area Network (LPWAN) considering low power communication, and is not limited to the above-described names. As an example, ZigBee technology can generate personal area networks (PANs) related to small/low-power digital communication based on various standards such as IEEE 802.15.4, and may be called various names.

The embodiments described above are those in which components and features of the present disclosure are combined in a predetermined form. Each component or feature should be considered optional unless explicitly stated otherwise. Each component or feature may be implemented in a form that is not combined with other components or features. In addition, it is also possible to constitute an embodiment of the present disclosure by combining some components and/or features. The order of operations described in the embodiments of the present disclosure may be changed. Some configurations or features of one embodiment may be included in other embodiments, or may be replaced with corresponding configurations or features of other embodiments. It is obvious that the embodiments may be configured by combining claims that do not have an explicit citation relationship in the claims or may be included as new claims by amendment after filing.

In this document, embodiments of the present disclosure have been mainly described based on a signal transmission/reception relationship between a terminal and a base station. Such a transmission/reception relationship is extended in the same/similar manner to signal transmission/reception between a terminal and a relay or a base station and a relay. A specific operation described as being performed by a base station in this document may be performed by its upper node in some cases. That is, it is obvious that various operations performed for communication with a terminal in a network comprising a plurality of network nodes including a base station may be performed by the base station or network nodes other than the base station. The base station may be replaced by terms such as a fixed station, a Node B, an eNode B (eNB), an access point, and the like. In addition, the terminal may be replaced with terms such as User Equipment (UE), Mobile Station (MS), Mobile Subscriber Station (MSS).

In a hardware configuration, the embodiments of the present disclosure may be achieved by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In a firmware or software configuration, a method according to embodiments of the present disclosure may be implemented in the form of a module, a procedure, a function, etc. Software code may be stored in a memory unit and executed by a processor. The memory unit is located at the interior or exterior of the processor and may transmit and receive data to and from the processor via various known means.

As described before, a detailed description has been given of preferred embodiments of the present disclosure so that those skilled in the art may implement and perform the present disclosure. While reference has been made above to the preferred embodiments of the present disclosure, those skilled in the art will understand that various modifications and alterations may be made to the present disclosure within the scope of the present disclosure. For example, those skilled in the art may use the components described in the foregoing embodiments in combination. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL APPLICABILITY

The above-described embodiments of the present disclosure are applicable to various mobile communication systems.

1. A method performed by a first device, the method comprising:
acquiring first sensor data through a first sensor;
receiving second sensor data detected through a second sensor different from the first sensor from a second device; and
transmitting a vehicle-to-everything (V2X) message including object detection information based on the first sensor data,
wherein the first device determines the object detection information included in the V2X message, based on whether the first sensor data conflicts with the second sensor data.

2. The method of claim 1, wherein based on that the first sensor data conflicts with the second sensor data, the object detection information includes information about high-definition (HD) data of the first sensor data, which is not processed by the first device.

3. The method of claim 2, wherein the information about the HD data includes address information for accessing the HD data.

4. The method of claim 2, wherein the information about the HD data includes at least one of valid time information, video type information, maximum resolution information, or maximum frame number information, about the HD data.

5. The method of claim 1, wherein based on that the first sensor data does not conflict with the second sensor data, the first device configures the object detection information by processing the first sensor data.

6. The method of claim 1, wherein the V2X message includes information about a type of the second device providing the second sensor data.

7. The method of claim 6, wherein the type of the second device relates to whether the second device is a road side unit (RSU) or a central-intelligent transportation system (C-ITS) server.

8. The method of claim 1, wherein based on that a confidence level for an object detected through the first sensor is less than a threshold, the object detection information includes information about HD data of the first sensor data, which is not processed by the first device.

9. The method of claim 1, wherein based on that an object that cannot be identified by the first device is detected through the first sensor, the object detection information includes information about HD data of the first sensor data, which is not processed by the first device.

10. The method of claim 1, wherein based on that a predefined emergency situation occurs, the object detection information includes information about HD data of the first sensor data, which is not processed by the first device.

11. A non-transitory computer-readable recording medium having recorded thereon a program for performing the method of claim 1.

12. A first device comprising:
a first sensor;
a transceiver; and
a processor controlling the first sensor and the transceiver,
wherein the processor acquires first sensor data through the first sensor, receives second sensor data detected through a second sensor different from the first sensor from a second device, and transmits a vehicle-to-everything (V2X) message including object detection information based on the first sensor data, and
wherein the processor determines the object detection information included in the V2X message, based on whether the first sensor data conflicts with the second sensor data.

13. The first device of claim 12, wherein based on that the first sensor data conflicts with the second sensor data, the object detection information includes information about high-definition (HD) data of the first sensor data, which is not processed by the first device.

14. The first device of claim 13, wherein the information about the HD data includes address information for accessing the HD data.

15. The first device of claim 13, wherein the information about the HD data includes at least one of valid time information, video type information, maximum resolution information, or maximum frame number information, about the HD data.
